(19) United States
(12) Patent Application Publication
(10) Pub. No.: US 2022/0229025 A1
(43) Pub. Date: Jul. 21, 2022

(54) CHROMATOGRAPHY BEADS CONTAINER LIFTING SYSTEM

(71) Applicant: Marcellus Johannes Hubertus RAEDTS, BS Emmen (NL)

(72) Inventor: Marcellus Johannes Hubertus RAEDTS, BS Emmen (NL)

(21) Appl. No.: 17/608,578

(22) PCT Filed: May 4, 2020
(86) PCT No.: PCT/NL2020/050284

§ 371 Date: Nov. 3, 2021

(30) Foreign Application Priority Data
May 3, 2019 (NL) 2023071

(51) Int. Cl. G01N 30/56; G01N 30/52

(52) U.S. Cl. CPC G01N 30/56; G01N 2030/521; G01N 2030/562; G01N 30/52

(57) ABSTRACT

Disclosed is an equipment including a container filled with chromatography beads for capturing a product present in a process liquid or to prepare them for subsequent use. The equipment also includes a supporting frame standing on the ground and providing support for the container such that the container is spaced above the ground. Outside the container there is provided a lifting system fastened to and supported by the supporting frame and fastened to a part of the container such that the part of the container can be raised by the lifting system relative to the supporting frame and another part of the container. At least part of the lifting system extends aside the container from the bottom to the top of the container.

The present invention relates to the field of a container filled with chromatography beads. On the one hand a container for capturing a product present in a process liquid, designed as a “packed bed” chromatography column (also abbreviated by “column”), e.g. of axial or radial flow type, for liquid chromatography comprising a packed bed (also abbreviated by “bed”) of beads, in particular for downstream processing of biologics from natural source like milk, plasma, extracts, etc. or engineered like in cell culture or cell fermentation harvests, e.g. for laboratory analysis operations or for industrial scale production operations in which separation steps such as fractionation from human blood or capturing or removing impurities from a pharmaceutical can be carried out on a large scale in a batch process or a continue process. On the other hand a container designed as a preparation vessel (also abbreviated by “vessel”) with a “fluidized bed” or “slurry” to process/utilize the chromatography beads in a pressure-less manner to prepare them for use in the “packed bed” chromatography column.

General and specific background about chromatography are provided by U.S. Pat. Nos. 4,627,918A, 4,676,898A, 5,466,377A, WO2014/092636, WO03059488, WO2007/136247 and WO2019/143251.

The material for the packed bed can also be called “adsorbent” or “gel” or “resin” or “matrix”. The beads can be small or large in diameter, e.g. beads having a diameter between and 1100 micrometre (0.01-1.1 millimetre), e.g. having a diameter of 20-100 or 100-300 or 300-500 or 500-800 or 800-1100 micrometre (equals 0.02-0.1 or 0.1-0.3 or 0.3-0.5 or 0.5-0.8 or 0.8-1.1 millimetre, respectively).

The column or vessel has a cylindrical, square or any other shape, seen in axial view, and has an internal processing volume, to contain the beads. This internal processing volume is delimited by a circumferential, axially extending, e.g. cylindrical, wall (during normal operation the axially upward or vertical extending wall), at both axial ends closed or sealed by a top wall and an opposite bottom wall, also called “bulkhead” (during normal operation the horizontally extending top or upper and bottom or lower wall, respectively). The internal processing volume is preferably between 10 and 1000 or 5000 litre. The axial direction of the column or vessel is upright or vertical during normal, upright standing, operation.

Both the column and the vessel contain a, preferably plate like, filtering wall (also named “filter”, “sieve” or “frit”) adapted to the size of the beads for retaining the beads while allowing liquid to pass, and one or more inlet ports and one or more outlet ports for the supply and extraction, respectively, of liquids and beads. The column is provided with an axial (also named “vertical” or “upright”) and/or radial (also named “horizontal”) extending filter. Preferably, the column comprises at least one or two mutually spaced vertical extending filters, preferably provided concentrically to provide the torus or doughnut shape of the packed bed. The vessel preferably is provided with a radial (also named “horizontal”) extending filter adjacent the bottom wall (also named “bottom filter), e.g. keeping a gap of less than 5 or 30 or 50 or 100 millimetre with the bottom wall; and/or an axial extending filter.

For the vessel bottom filter one or more of the following preferably applies: in the shape of a funnel or reversed dome, having its lowest point at the axial centre of the vessel (or: the centre of the vessel bottom wall, seen in top view); comprises a laminate of at least two or three layers and/or is spaced from the bottom wall of the vessel; is located above and/or for at least 80% or 90% or completely covers the vessel bottom wall and/or the area enclosed by the vessel circumferential wall, e.g. is sealed to the vessel circumferential wall along its complete circumference or provided in an alternative manner such that liquid internal of the vessel and at the side of the bottom filter facing the vessel top wall can only enter the space internal of the vessel at the opposite side of the bottom filter by passing the bottom filter; its surface facing the internal of the vessel (i.e. the top face or upward directed face during normal operation of the vessel) is such that the gel cannot enter the cavities of the bottom filter, i.e. the filter surface porosity is smaller than the bead size of the gel (this provides that the beads of the gel will always stay on top of the filter surface); is designed such that the beads stay on top and can not sink into the top face of the bottom filter.

For the vessel axial filter one or more of the following applies: a short radial distance from, and preferably concentrically with, the vertical or upright wall of the vessel, preferably sealed to another element of the vessel, e.g. the bottom filter and/or the vessel bottom wall and the vessel upright wall at its lower and upper, respectively, edges; the spacing between the vertical filter and the vertical wall is between 1 or 5 and 10 or 20 or 30 millimetre; the top edge of this vertical filter is above the maximum fill level (for the gel) of the vessel; extends at least 50% or 80% the height of the upright vessel wall and/or completely circumferentially.

For a filter preferably one or more of the following applies: made from stainless steel, preferably sintered, or made from plastic or polymer material; granulate, printed (i.e. by 3D printing) or woven; electro polished surface; hydrophilic surface; comprising at least or exactly one or two or three or four layers or sheets of woven wires of stainless steel, directly laid on top of each other, at least one of the sheets, e.g. the sheet providing the (during normal operation) top face or upward or inward facing face of the filter, preferably, e.g. when woven, with a fine and/or well defined porosity, preferably woven according to a plain weave or twilled weave or plain dutch weave or twilled dutch weave or reversed plain dutch weave or reversed twilled dutch weave or five-peddle weave pattern; the sheets provide a united assembly, preferably are mutually sintered (also called diffusion bonded); at least one or two, e.g. each, sheet is woven from wires having a diameter at least 10% or 20% different, e.g. larger or smaller, from the immediately adjacent sheet; the wire thickness among sheets increases from the one to the other face of the filter, preferably from the (during normal operation) top face or upward or inward facing face; the wire thickness of the sheets is at least 25 or 50 micrometre (equals 0.025 and 0.05 millimetre) and/or not more than 500 micrometre (equals 0.5 millimetre); at least one or two, e.g. each, sheet has a pore size at least 10% or 20% different, e.g. larger or smaller, from the immediately adjacent sheet; the pore size among sheets increases from the one to the other face of the filter, preferably from the (during normal operation) top face or upward or inward facing face; the sheet, e.g. reinforcement sheet, having the thickest wires and/or largest pore size, e.g. at least 500 micrometre (0.5 millimetre) is the, preferably ultimate, inner- or outermost sheet of the filter, preferably the sheet the most remote from the (during normal operation) top face or upward or inward facing face; thickness at least 0.3 or 0.8 or 1.0 millimetre and/or not more than 1.2 or 1.5 or 1.8 or 3.5 millimetre; pore size (this is the “nominal” pore size, defined by the diameter of the largest or smallest rigid sphere that can pass the pore) at least 1 or 10 or 50 or 100 and/or not more than 100 or 200 or 500 micrometre (equals 0.001, 0.01, 0.05, 0.1, 0.2 and 0.5, respectively, millimetre); contains a single filter layer; a filter layer is directly exposed to the contents of the column or vessel, e.g. the gel; at the side of the filter layer facing upward or inward (during normal operation), a layer, e.g. protective layer, is absent; a filter layer provides the surface layer; has at the one side of a filter layer no layer or merely a protective layer and at the other side merely a protective or dispersion layer and possibly exactly one or two further layers, preferably reinforcing layers; provides a filtering wall or filtering membrane, preferably having and/or covering a surface area at east 25 or 50 or 75 or 90% the surface area of the adjacent external wall of the container (e.g. in case of the column the circumferential, axially extending column wall and in case of the vessel the bottom wall) and/or at least 500 or 1000 or 2000 square centimetre; acts like a sieve; has an outstretched shape, e.g. like a container wall; is non-corrugated and/or non-folded; is expanded.

For the column, the invention is specifically applicable to the column type with horizontal or radial flow, although the invention is also applicable to the column type with axial flow. As used herein, the terms “horizontal” and “radial flow”, which are used interchangeably, are defined as flow of the liquid or sample (e.g. biomolecules) or eluant or wash fluid through the packed bed of the column in a direction that is perpendicular to the longitudinal axis or axial direction of the column. Preferably, the column is constructed so as to have concentrically and in register an inner and outer annulus of equal axial length, each providing a filter, with the matrix material being packed there between. The top and bottom edge of these two concentric filters are sealed to a top and bottom seal plate. The packed bed thus has a torus or doughnut shape, sealed at the axial top and bottom side by the seal plates, and the flow through the packed bed is radially from the one to the other concentric filters. The bed height is thus computed as the distance between the inner and outer annuli. Radial flow is particularly advantageous for high performance low pressure chromatography used in conjunction with the separation of biomolecules like proteins or other organic or inorganic compounds particularly sensitive to shear forces. Such horizontal or radial flow columns are, e.g., disclosed in U.S. Pat. Nos. 4,627,918 and 4,676,898.

The vessel is meant to facilitate and automate the execution of a number of beads related processing steps, mainly but not exclusively in conjunction with preparation/cleaning/activation/collection to waste/adsorption or desorption. One of the applications of the vessel is replacing the liquid that contains the beads, e.g. buffer exchange. Also decanting, de-fining and concentration adjustment can be carried out with the vessel. Or making the beads ready for re-use (e.g. washing, treating, cleaning, etc.). Or preparation for concentrated storage after use, or homogenizing. In all such cases the beads are free flowing inside the vessel in a mixed state.

Typically, the vessel is provided with a mixer, preferably equipped with blades or designed in an equivalent manner to gently but efficiently homogenize the content of the vessel by mixing action. Preferably, an electric drive motor for the mixer is mounted on top of the top wall of the vessel.

The column typically operates at elevated internal pressures relative to the environmental pressure of 1 Bar, typically between 2 and 4 Bar above environmental pressure, meaning that the process liquid is supplied to the column at said elevated internal pressure and flows through the packed bed of beads. These substantial elevated internal operating pressures require security measures of high level, also for maintenance to the column.

The vessel typically operates with gravity action, meaning that gravity action alone is the driving force for the flow through the filter. Alternatively, in addition to the gravity action, gentle suction at the outlet and/or gentle overpressure in the headspace is applied, such that in this case gravity action is mainly the driving force for the flow through the filter. The top bulkhead carries the mixer and its drive unit, making it a heavy weight subassembly which requires security measures of high level, also for maintenance to the vessel.

Hereafter, the column and vessel are commonly called “container”. “Axial view” also means “top view” in operation.

The object of the present invention is to offer a high security level during manipulation of a subassembly (e.g. comprising the top bulkhead) of the container, wherein said subassembly is, effortless yet highly accurate, lifted from the rest of the container, e.g. for maintenance, inspection or replacement of a screen, e.g. of disposable and/or axial type, preferably without the need of an external lifting equipment. For a clean-room environment, which is typically the case for the present container, a hoist mounted to the ceiling of the room is very undesirable.

The container is preferably an assembly of a number of separable subunits and is mounted on a supporting frame that can offer an array of functions, uniquely or in combination. Primarily the frame is meant to support the container and should offer a sturdy base, featuring height adjustable feet or optionally it can be executed with freely rotating castors to freely move the container. Sensors are preferably installed to assess and monitor the filling level of the container, depending on the most effective match with the type of application and/or execution, sensors can act by differential weight, differential static pressure or actual liquid level height monitoring. Hence the liquid handling processes can be completely automated or controlled by an operator.

The frame preferably has a horizontal base, preferably provided by a U- or V-shaped space frame, carrying at its downward facing side the feet or wheels and/or at its upward facing side the container is located, perhaps having its bottom level with the base or there below. The U- or V-shape facilitates access to the container bottom functionalities, e.g. liquid ports. Preferably, the container fits within the footprint of the frame or its base, more preferably between the legs, in axial view.

The frame is equipped with an integrated synchronous lifting system that will separate and lift the upper assembly from the bottom assembly and/or the upper assembly from the vertical filter. The lifting system itself typically consists of at least two and preferably less than six, mutually spaced, lifting actuators, acting together in a tightly controlled synchronous action to keep the centre of gravity of the lifted assembly within tight tolerance of the centre of gravity of the complete unit, to allow safe lifting of the upper assembly and to ensure absolutely vertical (also called “axial”) concentric lifting such that the separation of, e.g., the upper assembly from the rest of the container, e.g. the vertical filter assembly, will be done without contact between components, e.g. the wall, of the upper assembly and components of the rest of the container, e.g. the vertical filter assembly. When less than 3 lifting actuators are applied, additional sturdy vertical guides (“guard rails”) can assist the stability of the vertical lifting and ensures keeping concentric tolerances within given limits.

Preferably, the lifting actuators and guides are distributed, in axial view, around the axial outer wall of the container, in other words they surround or envelope it, preferably with close radial spacing for compact design; and/or extend, fully retracted, and/or have a stroke at least 50% or 75% and/or less than 100% or 150% or 200% the container height, e.g. from the bottom level to the top level; and/or are fastened, e.g. by, e.g. releasable, fastening means, to the container and/or mixer top (e.g. container top wall, also named “lid”) to lift the container and/or mixer suspending from the relevant top.

Preferably one or more of the outer axial wall, an axially extending internal wall, e.g. outer frit or sieve and other axially extending components are releasably mounted to the container top in such a manner that their mounting to the container top can be released without opening the container (e.g. through externally accessible mounting means, e.g. screws or bolts), such that one can select which such component remains mounted to the container top to become lifted by the actuators, through lifting of the container top, while released components stay behind. Obviously, such components to be lifted should have their mounting with the container bottom be released prior to lifting, wherein preferably they are releasably mounted to the container bottom in such a manner that their mounting to the container bottom can be released without opening the container (e.g. through externally accessible mounting means, e.g. screws or bolts).

The lifting actuators are e.g. of linear and/or telescopic type and are mutually spaced around the circumference of the container, externally from the container. They extend axial and/or vertical and external of the container, e.g. from the bottom part of the frame, e.g. its base, upward and are mounted, on the one hand to the frame and on the other hand to the container in a manner such that lifting of the container, or part of it, relative to the frame is made possible.

The mounting of the lifting actuators at low level, e.g. to the supporting frame, is preferably free standing and/or like an outrigger and/or cantilevered.

There are preferably two different lifting systems and the choice and execution of the lifting system e.g. corresponds to the force that is required to separate the assembly, i.e. the weight to be lifted. For lighter assemblies an electrical linear drive actuator will suffice, when the assembly is heavier or equipped with less actuators, hydraulic actuation, e.g. a piston moved within a cylinder, is preferred.

The lifting system, e.g. any of both above lifting systems, electric linear drive or hydraulic, preferably meets the requirement that tightly controlled synchronous movement is required for reasons of safety, proper operation and tight fit. Electric linear drive units are preferably equipped with an around its axis rotating spindle associated with an accurate rotation encoder allowing adjustment and tuning of individual actuators such that synchronous movement within a level tolerance of <0.1 mm is guaranteed.

Synchronous hydraulic actuation of more than 1 actuator is preferably controlled with enough accuracy by valve clipping and/or accurately distributed pressure and it is assumed that this is only possible when there is accurate and instant feedback from each hydraulic actuator about its absolute position in the synchronous moving set of actuators. Differences in resistance to move of individual actuators can obscure the synchronicity in hydraulic operation when the synchronous movement would be dependent on equalized pressure in the cylinders and by controlling the absolute position any uneven load or resistance is therewith irrelevant for the synchronous lifting. The synchronous lifting is preferably only based on the actual and absolute axial position or extension of each actuator of the set. The high-pressure hydraulic valve system is preferably controlled to accurately distribute the hydraulic fluid provided by a single hydraulic pump such that it will accurately deliver the amount of force/pressure to each of the actuators resulting in synchronous movement within a level tolerance of <0.1 mm over the complete actuator stroke length. The distribution of hydraulic fluid to enable accurate synchronized operation of multiple units preferably requires a setup including high precision and tightly controlled high pressure proportioning valves fed by a single hydraulic pump.

Special requirements of any application of mechanical equipment in a pharmaceutical production environment is the “sanitary design” of such solution. Accepted sanitary design solutions minimize chances for microbial growth “by design” and offer effective clean-ability for all areas that could create a danger for microbial growth. Materials that are applied need to be protected or resistant to corrosion, aggressive liquids and should by-design minimize the application of any kind of external add-on which can and will create a conflict with respect to a risk of microbial growth.

The hydraulic fluids used in a hydraulic system preferably comply to the regulations of use within a pharmaceutical environment and are intrinsically safe when accidentally released in the area.

Preferably, the actual and accurate measurement of the absolute position (e.g. extension) of the or each actuator is measured by a, preferably internal of the actuator, measurement system, e.g. provided with a, in particular for the hydraulic linear actuator, internal of the actuator, axial and in a straight line extending, preferably high-resolution, reference element, e.g. ruler-guide, with preferably an absolute position accuracy of at least +/−0.01 mm over the complete stroke length of the actuator. The information of each absolute position within the synchronous acting set of actuators is fed back to a controller that translates the individual position information to a distribution of fluid/pressure to each of the individual actuators.

Preferably one or more applies to the reference element: is of axial linear type; axially extends at least the complete stroke length; is enveloped or surrounded by and/or projects through the piston (“piston” also refers to another extension providing member of the actuator) and/or piston rod, e.g. into an axial recess of and extending at least 50% the length of the piston rod; is concentric with the piston and/or piston rod; has a prismatic shape; is fixed relative to the piston; extends from the fully retracted to the fully extended position of the piston; is axially provided with a scale; is associated with a sensor that is designed to detect the relative axial position of the piston and the reference element; the sensor and piston are combined such that they move as one; the sensor is communicatively connected to the controller.

The transfer of the electrical signals to and from the actuator sensors, e.g. associated with the position measurement system and/or to and from the controller is preferably done by cables fed enclosed in the piping of the frame, protected from external influence and itself protected by the enclosure for sanitary by design.

The hydraulic fluid to retract the extended piston or to extend the retracted piston of the actuator is preferably not fed by an external pipe or channel like commonly applied, but supplied internally, preferably via an axial extending, annular channel preferably provided by the gap between the radial external wall of the linear actuator and a with spacing provided, the linear actuator circumferentially enclosing sleeve like casing, e.g. a concentric cylinder which e.g. also represents the outer body of the linear actuator. By this setup no extremities that are difficult to clean are present and sanitary design is achieved. Only by this complex combination of attributes supporting accurate movement without adding any devices or extremities that are in conflict with pharmaceutical production (GMP) and sanitary design, the accurate and safe lifting of any vessel assembly is possible.

The following provides a detailed description of the preferred functioning of the tightly controlled synchronized hydraulic embodiment of the lifting system.

To ensure the compatibility for all the components that act together for an accurate synchronous movement, the internal and external dimensions of the hydraulic actuator is preferably calculated so the maximum load of the assembly in any form is processed by a hydraulic pressure limit between 20 or 50-100 Bar by synchronous operation of at least 2 and maximally 6 actuators.

To offer the best possible sanitary design the hydraulic actuator is preferably executed in high grade mirror polished stainless steel and has been designed without extremities like hydraulic pressure lines and/or fittings. Extension- and retract-pressure lines are preferably connected to the bottom plug of the main cylinder housing or cylinder barrel. Extension fluid/pressure is preferably directly delivered into the extension chamber below the piston. The retracting fluid/pressure is preferably fed to the top of the actuator assembly by preferably the double wall barrel creating a narrow channel or gap by concentric alignment. The hydraulic lines between the hydraulic pump and the linear actuators preferably extend inside the frame.

Actuators preferably have a stroke length between 30 cm and 300 cm. A single hydraulic pump, common to all actuators, preferably delivers the hydraulic fluid under preferentially constant pressure preferably to a valve system with preferably alternating proportional valves controlled by a computer, preferably a high-speed PLC, with the data input of a, preferably high accuracy, piston positioning sensor in each of the actuators/pistons.

In case exactly three elements are present from the group: actuators and vertical guides (i.e. three actuators or one or two actuators and two or one, respectively, vertical guides), preferably the elements are located, seen in top view of the container, at the corners of an imaginary triangle wherein preferably not all sides of the triangle have equal length, preferably two sides have equal length and are longer than the third side (viz. e.g. FIG. 9B). The difference in length is preferably at least 10 centimetre or 5 or 10 percent.

The external wall of the linear actuator is preferably made of stainless steel, e.g. one of: 1.4403, 1.4404, 1.4435, 1.4539, 1.4462, 304(L) 316(L), 904(L), Duplex.

### NON-LIMITING EXAMPLES

The accompanying drawings, which are incorporated and form a part of the specification, illustrate presently preferred embodiments of the invention and, together with the description, serve to explain the principles of the invention. Shown is in:

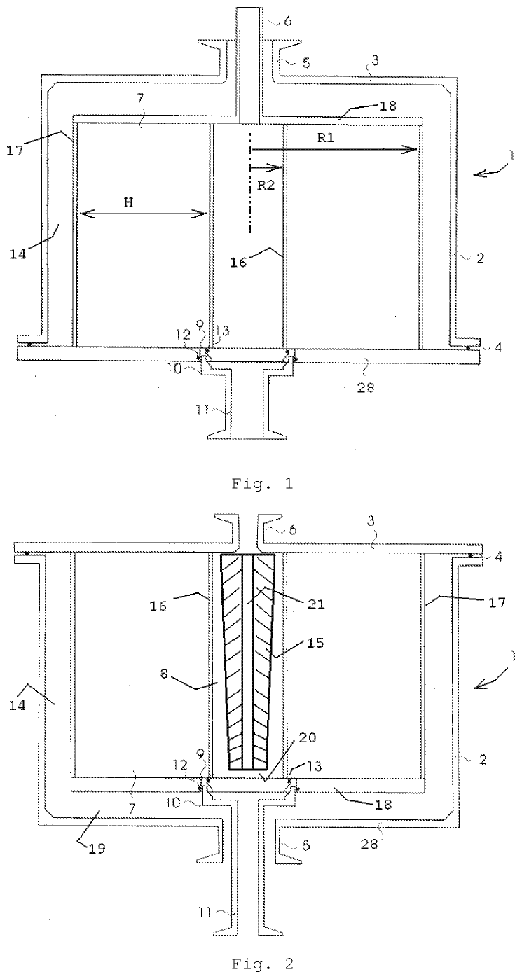

FIG. 1-3 examples of a chromatography column of radial type in sectional side view;

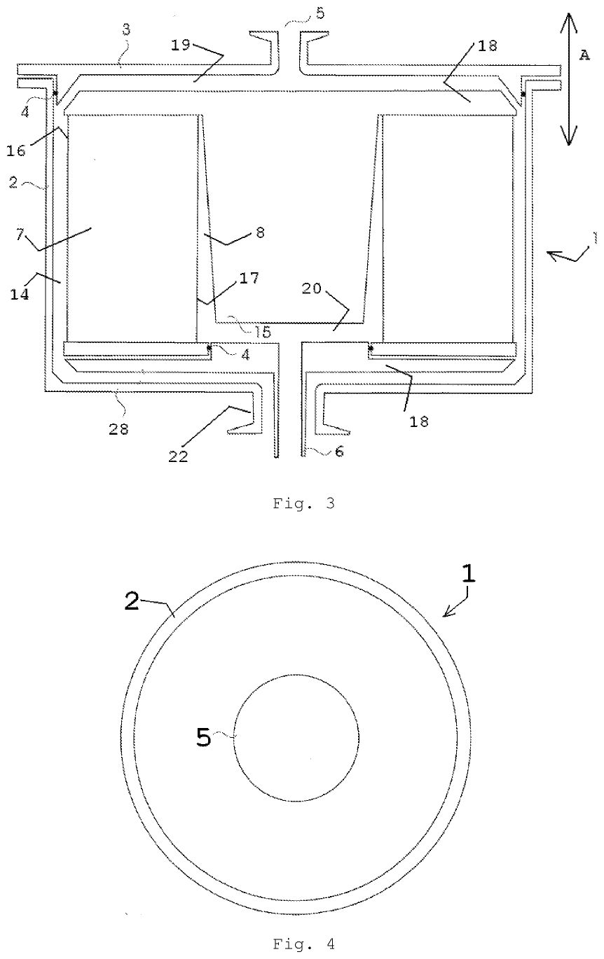

FIG. 4 the column of FIG. 3 in top view;

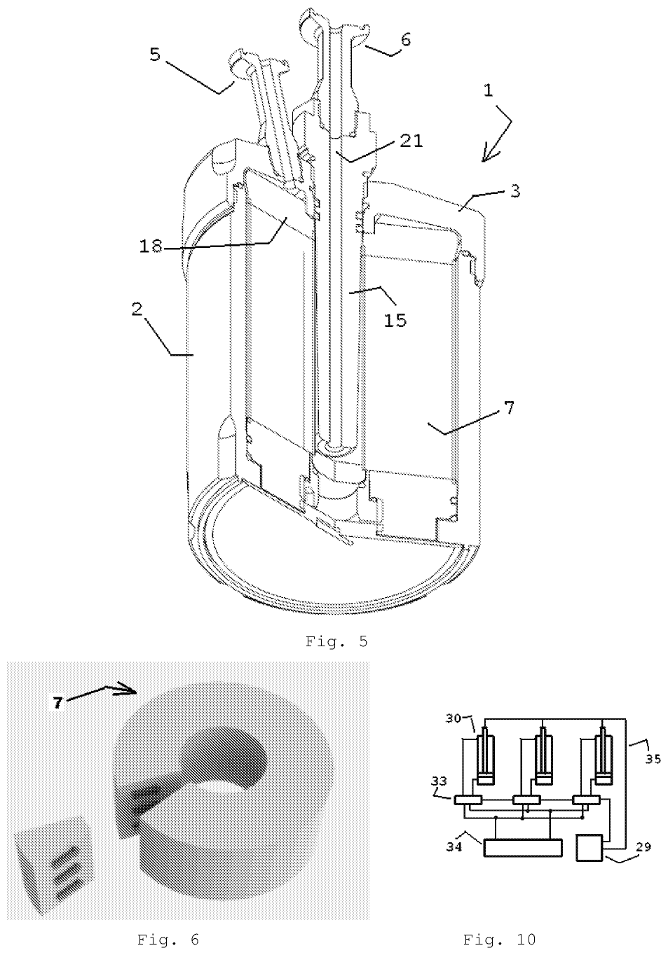

FIG. 5 another column in perspective view from below, partly cut away;

FIG. 6 a perspective view of a torus shaped filter bed;

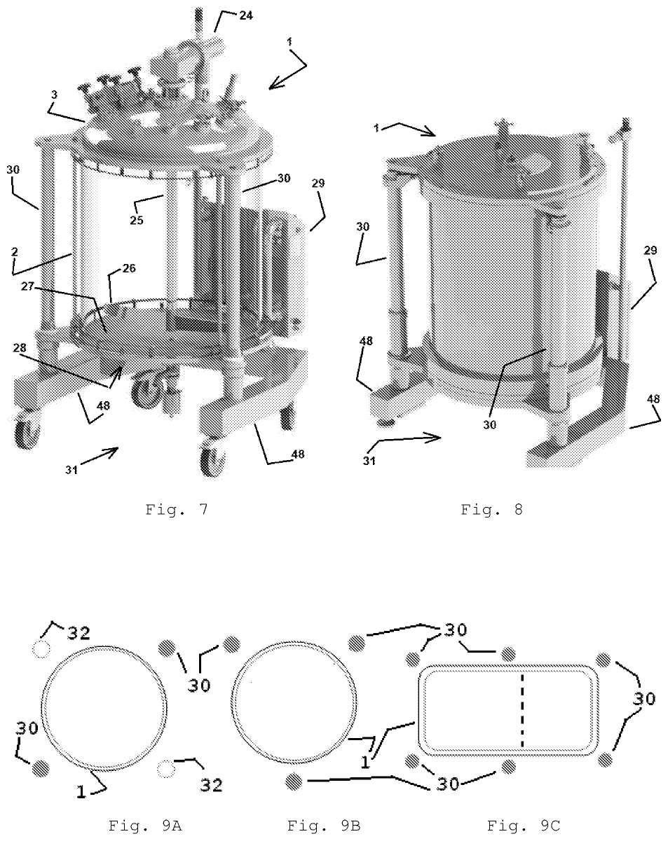

FIG. 7-8 a perspective view of two examples of the container mounted in a wheeled frame;

FIG. 9A-C different arrangements of linear actuators and guardrails, in top view;

FIG. 10 an example of the hydraulic circuit;

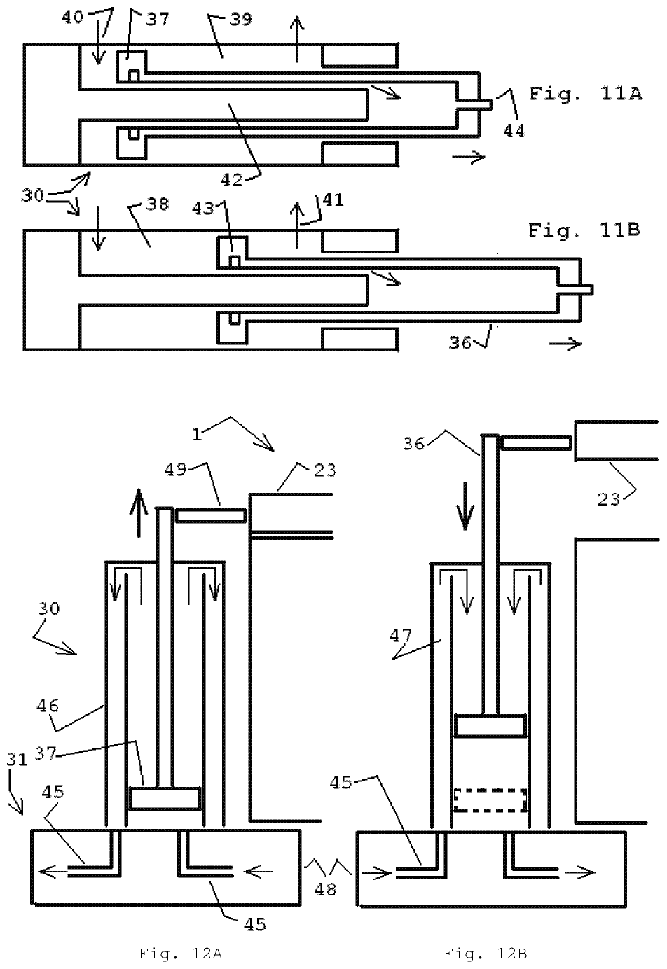

FIG. 11-12 a sectional side view of the hydraulic actuator;

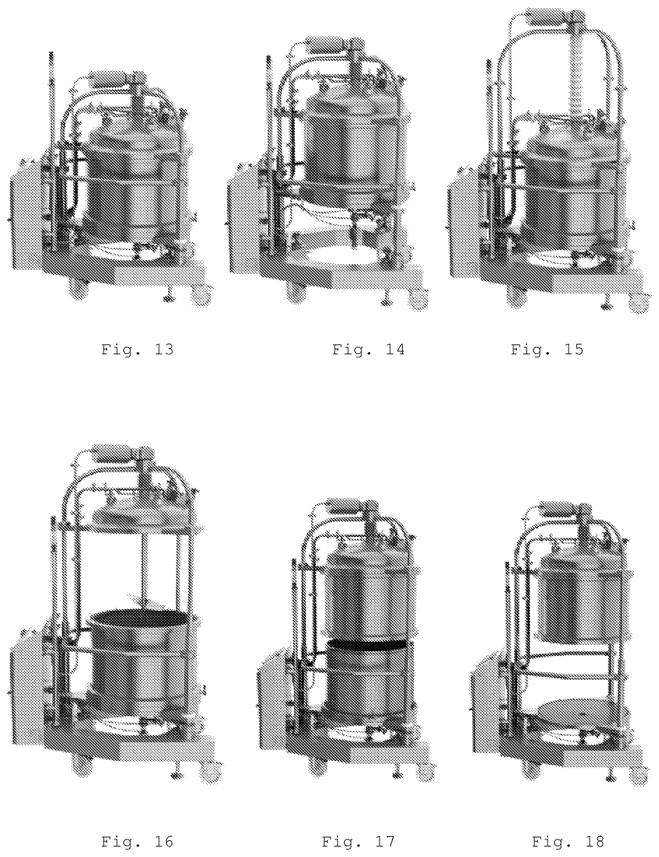

FIG. 13-18 possible lifting positions of the container;

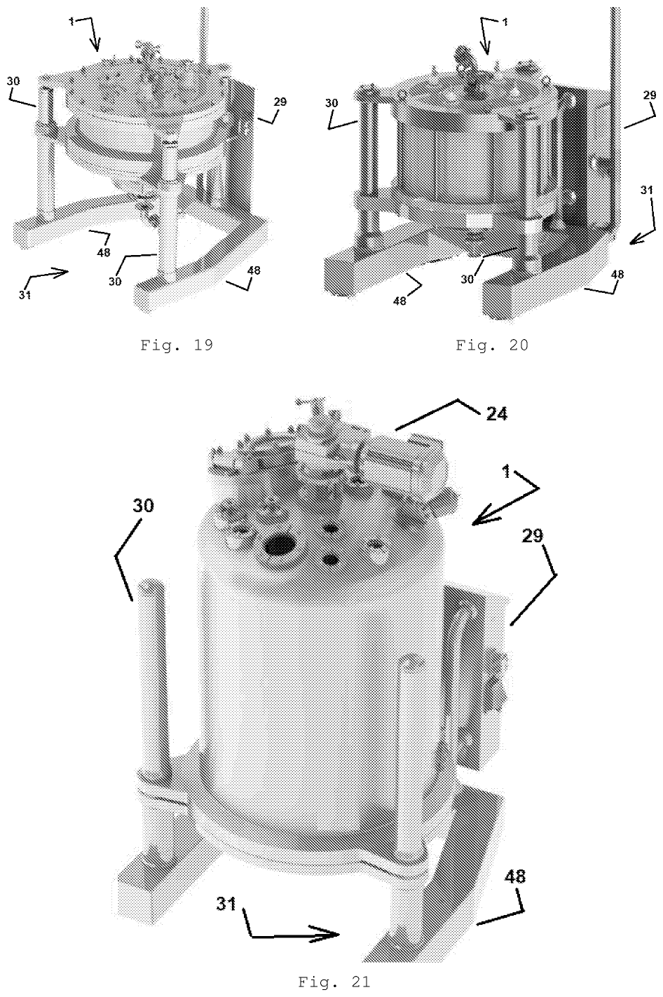

FIG. 19-21 alternatives to FIG. 7-8, in perspective view.

The following reference numbers are used: container 1 (either column or vessel); cylindrical housing wall 2; axial housing end plate (also called top wall or lid) 3; seal 4; liquid inlet 5; liquid outlet 6; packed bed 7; inner flow channel 8; packed bed fill opening 9; connector 10; fill tube 11 for packed bed; seal 12; seal 13; outer flow channel 14; core 15; inner frit 16; outer frit 17; axial bed end plate 18; distribution space 19; collector space 20; outflow channel 21; liquid outlet 22; axial housing end plate (also called bottom wall) 28; bed height H; outer frit radius R1; inner frit radius R2; axial direction arrow A (FIG. 3). The radial direction is perpendicular to the axial direction.

Each of the containers 1 (e.g. liquid chromatography columns) shown in FIG. 1-5 comprises: a housing, of cylindrical shape, defining a chamber therein and including a removable axial end plate 3 of circular shape; a first (outer) and second (inner) porous frits 16, 17 or membranes of cylindrical shape; a bed 7 or packing of particulate chromatographic separation material positioned intermediate said porous frits; optionally an axially extending core 15. The axially extending cylindrical external housing wall 2, first 17 and second 16 frit and core are coaxial.

The torus shaped packed bed 7 (schematically illustrated in FIG. 6, wherein a wedge shaped piece has been taken out for clarity) allows the radial flow (according to the arrows in FIG. 6) of process liquid through the column 1, from the outer frit 17 to the inner frit 16.

FIG. 7 illustrates the container 1 as a preparation vessel, supported by a wheeled frame 31 (U-shaped in top view). Above the top wall 3 a drive motor 24 is present from which a drive shaft 25 extends vertically downward towards mixing vanes 26 at the bottom of the vessel, to mix the vessel contents. Below the mixing vanes the bottom filter plate 27 is present just above the vessel bottom wall 28. The control box 29 at the back contains the control unit and the hydraulic valves to control the three from the frame 31 upward extending linear actuators (only two visible) from which the container 1 is suspended. The hydraulic motor (not shown) is located remote from the vessel. The mounting of the linear lifting actuators 30 at low level, i.e. to the supporting frame, is free standing (i.e. like an outrigger or cantilevered).

In FIG. 8 the container is e.g. a chromatography column. To ensure stable and accurate vertical movement of the vessel 1 or part of it by the lifting system, FIG. 9A applies two linear actuators 30 and two guard rails 32, FIG. 9B three linear actuators 30 and FIG. 9C six linear actuators. FIGS. 9B and 9C apply no guard rails 32. The vessel of FIG. 9C is right angled in top view, could be square (see dotted line) having e.g. four actuators 30. FIG. 9A could apply four actuators and no guard rails 32. Different combinations of actuators 30 and rails 32 are feasible.

In FIG. 10 three actuators 30 are controlled in synchronism by control valves 33, individually controlled by control box 29, receiving individual actuator position feed back through sensor line 35. The valves 33 control the supply of pressurised liquid from reservoir 34 to the individual actuators 30.

In FIG. 11 (completely retracted/partly extended) the linear actuator 30 has an extension rod 36 integral with piston 37 separating an extension chamber 38 from retraction chamber 39. During extension of the rod 36, liquid enters chamber 38 at 40 and leaves chamber 39 at 41. The displacement of piston 37 along actuator internal ruler 42, penetrating piston 42, is detected by sensor 43. Chamber 38, penetrating chamber 39, enveloping ruler 42, rod 36 and extending at opposite sides of piston 37, has a vent 44 at the distal rod end.

FIG. 12A-B show a leg 48 of the U-shaped frame 31 in section. The hydraulic actuator 30 is mounted on top and the hydraulic supply and exhaust lines extend in the interior of the leg 48 and connect to the lower end of the hydraulic cylinder 46. The flow direction of the hydraulic fluid inside the annular gap 47 of the double walled hydraulic cylinder is indicated by the arrows. FIG. 12A illustrates the start of extension of the piston rod 36 from the fully retracted state. FIG. 12B illustrates the start of retraction of the piton rod from an intermediate extended state. FIG. 12B also illustrates that the upper part 3 of the container has been lifted from the lower part by the hydraulic actuator through the bracket 49.

In FIGS. 13 and 15 the container 1 of FIG. 7 is in the lower operating position, actuators 30 fully retracted (FIG. 13) or extended (FIG. 15), in FIG. 14 in the upper operating position, actuators 30 partly extended. By extension, the actuators 30 lift the complete container 1 (FIG. 14) or only the mixing vanes 26 and associated motor 24 and shaft 25 (FIG. 15). In FIG. 16 the top wall 3 (after being released from the container 1) is lifted by the fully extended actuators 30. In FIG. 17 the wall 2 (after being released from the bottom wall 28) is lifted, leaving the outer frit 17 unlifted. In FIG. 18 the bottom wall 28 and bottom filter plate 27 remain unlifted.

The measures disclosed herein can be taken together individually in any other conceivable combination and permutation to provide an alternative to the invention. Included are also technical equivalents and genuses or generalizations of the revealed measures. A measure of an example is also generally applicable within the scope of the invention. A measure disclosed herein, e.g. of an example, can be readily generalized for inclusion in a general definition of the invention, for example to be found in a patent claim.

1-17. (canceled)

18. An equipment comprising:
a container designed to be filled with chromatography beads and provided with a container top wall;
wherein the container contains a filtering wall adapted to the size of the beads for retaining the beads while allowing liquid to pass, and at least one inlet port and at least one outlet port for the supply and extraction, respectively, of liquids and beads;
a supporting frame standing on the ground and providing support for the container such that the container is spaced above the ground;
wherein the container and supporting frame are assembled as an integral, rigid, compact equipment for selective positioning on the floor of a human accessible process room;
outside the container a lifting system fastened to and supported by the supporting frame and fastened to the container top wall, the lifting system having a lowered and a raised position such that said container top wall is raised by the lifting system in the raised position relative to the supporting frame;
the lifting system is provided onboard the equipment;
wherein at least part of the lifting system extends aside the container from the bottom to the top of the container;
and wherein the lifting system comprises at least one upward extending elongated lifting actuator, of linear type, fastened to the supporting frame at the one longitudinal end and fastened to the container top wall at the opposite longitudinal end such that operation of the lifting actuator causes said raising of the container top wall.

19. Equipment according to claim 18, wherein the container is filled with chromatography beads.

20. Equipment according to claim 18, wherein the container is a container for capturing a product present in a process liquid, designed as a “packed bed” chromatography column, or wherein the container is a container designed as a preparation vessel to process or utilize the chromatography beads to prepare them.

21. Equipment according to claim 18, wherein axial elongation or extension of the lifting actuator causes said raising of the container top wall and wherein the lifting actuator is of electric or hydraulic type.

22. Equipment according to claim 18, wherein the lifting system is distributed around the container, in top view.

23. Equipment according to claim 22, wherein the lifting system comprises at least three lifting actuators which are provided at mutual angular spacing, in top view, each fastened to a relevant adjacent location of said container top wall to provide a static balanced support of said container top wall by the three lifting actuators.

24. Equipment according to claim 18, wherein the lifting actuator internally comprises a measuring means to measure the axial extension or expansion of the lifting actuator and wherein the measuring means comprises a reference element, concentric inside the piston and/or piston rod and of axial linear type and axially extending at least the complete lifting actuator stroke length.

25. Equipment according to claim 18, wherein the lifting actuator comprises an internal supply channel extending in axial direction and connected to the space in which the piston displaces during extension or expansion of the lifting actuator, to supply liquid to said space and wherein the internal channel is provided by a gap between two concentric located axial extending walls of the lifting actuator.

26. Equipment according to claim 18, wherein the supporting frame is U- or V-like shaped in top view.

27. Equipment according to claim 18, wherein the container is located inside the outer circumference of the supporting frame, in top view.

28. Equipment according to claim 18, wherein the container comprises one or more of: a mixer to mix the container contents; a filter plate; a torus like cavity containing the beads between concentric, axial filter walls.

29. Equipment according to claim 28, wherein one or more of the mixer, filter plate, axial container wall, torus like cavity are fastened to the container top wall by externally accessible fastening means, to be selectively released from the container top wall.

30. Equipment according to claim 18, wherein the complete container suspends from the lifting system in the raised position.

31. Equipment according to claim 19, wherein the filtering wall comprises at least two layers of woven wires of stainless steel, directly laid on top of each other providing a united assembly, each layer has a pore size at least 20% different from the immediately adjacent layer; a layer is directly exposed to the beads in the vessel.

32. Equipment according to claim 18, wherein the pores of the filtering wall have a pore size, defined by the diameter of the largest rigid sphere that can pass the pore, not more than 500 micrometre, which is equal to 0.5 millimetre.

33. Equipment according to claim 18, wherein the supporting frame has a horizontal base, provided by a U- or V-shaped space frame, carrying at its downward facing side the feet or wheels and at its upward facing side the container is located and the container fits between the legs of the space frame, in axial view.

34. Equipment according to claim 23, wherein the lifting actuators are distributed, in axial view, around the axial outer wall of the container, such that the lifting actuators surround or envelope the container, with close radial spacing.

35. Equipment according to claim 18, wherein the mounting of the lifting actuator at low level to the supporting frame is free standing.

36. Equipment according to claim 18, wherein the mounting of the lifting actuator at low level to the supporting frame is like an outrigger.

37. Equipment according to claim 18, wherein the mounting of the lifting actuator at low level to the supporting frame is cantilevered.
